(19) United States
(12) Patent Application Publication
(10) Pub. No.: US 2006/0188853 A1
(43) Pub. Date: Aug. 24, 2006

(54) Interactive literacy learning guide

(76) Inventor: Leon John Mismas JR., Hollywood, CA (US)

Correspondence Address: MARVIN H. KLEINBERG;KLEINBERG & LERNER, LLP, Suite 1080, 2049 Century Park East, Los Angeles, CA, 90067, US

(21) Appl. No.: 11/061,231

(22) Filed: Feb. 18, 2005

(51) Int. Cl. G09B 11/00

(52) U.S. Cl. 434/162

(57) ABSTRACT

An apparatus is provided to aid in teaching elementary writing skills to individuals. In the preferred embodiment, a dry-erase workbook, dry-erase markers and an interactive digital video disk are used which when played depicts the creation of exemplar characters. These are then copied into the workbook by the learner.

### BACKGROUND OF THE INVENTION

1. Field of the Invention

The present invention relates to learning guides and, more particularly, an interactive learning and teaching system for imparting elementary writing skills.

2. Description of the Related Art

In the past, teaching elementary writing skills was primarily a person to person arrangement with a teacher and a learner. The learner, at the outset, had no ability to create manuscript and required repetitive training to master the skill of writing an alphabet. Text books and work books were useful adjuncts to the process, but the teacher was important in providing examples and exemplars and could monitor the progress and correct the technique.

Teaching writing at the elementary level is time consuming and requires great skill and ability to train and aid in the development of the motor skills necessary for manuscript writing. While more and more individuals are becoming keyboard literate and acquire the ability to create text through machines, the art and skill of manuscript is still a necessity in daily life, ranging from the ability to sign a document to writing notes.

While teaching of the basic writing skills usually occurs in the elementary school for children, there is also a large number of individuals who are not in elementary schools but have never learned to write or, for that matter, to read. For these people, text and work books would require the presence of an instructor to teach the skills. It would be most useful if an interactive program could be provided that could educate a person lacking the prerequisite reading skills.

### SUMMARY OF THE INVENTION

In recent years, motion pictures have been used as an adjunct to learning in the classroom and interactive programs have been developed for teaching purposes. These have been most useful when the student can read and write and has mastered keyboard skills which limits their effectiveness to the upper grades of elementary school and higher. As a consequence, these programs have not been employed to teach the basic writing skills.

According to the present invention, an interactive system has been developed that combines the technology of the motion picture or video on DVD or graphic data discs with suitable marking implements such as dry erase marking pens and easily erasable work books. The motion picture and sound track provides instruction in the skills necessary to form the letters of the alphabet in both block and cursive characters. There is illustrated, on screen, the technique for creating a written character which can be followed by the student using the marker and the work book. Because in the preferred embodiment a dry erase marker is used in conjunction with a plastic coated page in the work book, mistakes can be easily corrected and lessons easily repeated.

In a preferred embodiment, animated cartoon characters are used to illustrate the methods of writing letters on a page at a pace that allows the student to follow and try to replicate the activity using the pen and work book page. The pages themselves are designed to provide adequate space in which to form the characters and, in a manner that has been previously employed, the work book has horizontal lines to provide boundaries for the characters. Other skill sets such as drawing straight lines and curved lines are shown on the screen to be copied by the student. These skills are employed when, in a later phase of the course, the straight and curved segments are combined to create characters such as numbers and letters.

In alternative embodiments, a suitable modified instructional program is created for adult learners who can neither read nor write the alphabet or the words that are created from the alphabetical characters. Such programs could be in different languages and could teach different alphabets such as Arabic, Cyrillic, Greek or any other alphabet capable of being utilized by a population. Appropriate adjustments would be needed in the layout of the work book and in the content of the instructional program.

Accordingly, it is an object of the present invention to provide an interactive learning system to impart literacy in an informal setting. It is an additional object of the invention to provide a learning system that does not require professional educators. It is a yet further object of invention to provide a combination of an audiovisual presentation with a coordinated work book to teach how to write alpha numeric characters. It is a yet further object of the invention to provide an audiovisual tutor with a reusable work book and writing implements that provide non permanent markings so that repetitive exercises can be undertaken.

The novel features which are characteristic of the invention, both as to structure and method of operation thereof, together with further objects and advantages thereof, will be understood from the following description, considered in connection with the accompanying drawings, in which the preferred embodiment of the invention is illustrated by way of example. It is to be expressly understood, however, that the drawings are for the purpose of illustration and description only, and they are not intended as a definition of the limits of the invention.

### BRIEF DESCRIPTION OF THE DRAWINGS

FIG. 1 is a plan view of an interactive literacy learning guide according to the present invention;

FIG. 2 is a perspective view of the learning guide of FIG. 1 with the work book portion opened;

FIG. 3 is a plan view of a typical page as depicted while viewing the data storage device according to a preferred embodiment of the present invention;

### DETAILED DESCRIPTION OF THE INVENTION

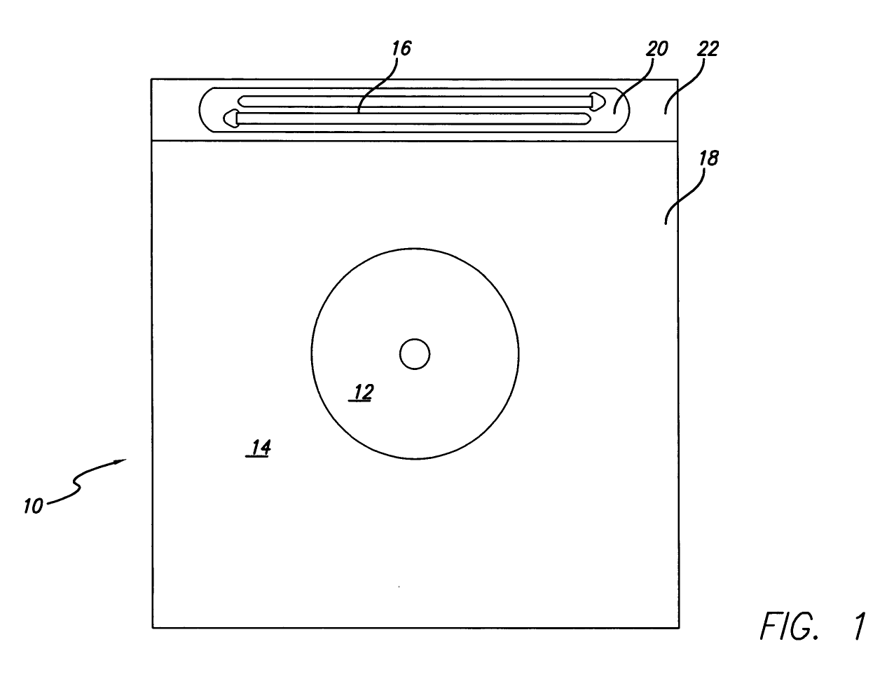

Turning first to FIG. 1, there is shown a preferred embodiment of an interactive literacy learning guide system 10 according to the present invention. The guide system 10 includes three components. A first component is a data disc 12 which, in the preferred embodiment, is a Digital Video Disc (DVD) containing an audiovisual presentation which includes examples and portrayals of how the written characters are to be formed. A second component is a work book 14 which includes pre printed pages with areas for practicing what is depicted in the audiovisual presentation. A third component of the system is an appropriate writing implement 16 which may be specially adapted for use by children with the limited motor skills commensurate with their relative immaturity. Additionally, in the preferred embodiment, the writing implement 16 is a dry-erase marker for use on the dry erase pages of the work book 14 that are also present in the preferred embodiment.

In the preferred embodiment, the data storage device 12 is mounted in the cover 18 of the work book 14. The writing implement (or implements) 16 is held in a case 20 which is mounted to a backing board 22 upon which the work book 14 is mounted, as well. In use, the work book 14 is opened to a work page and the data disc 12 is placed in an appropriate playing device which provides an audiovisual program that can be followed by the student.

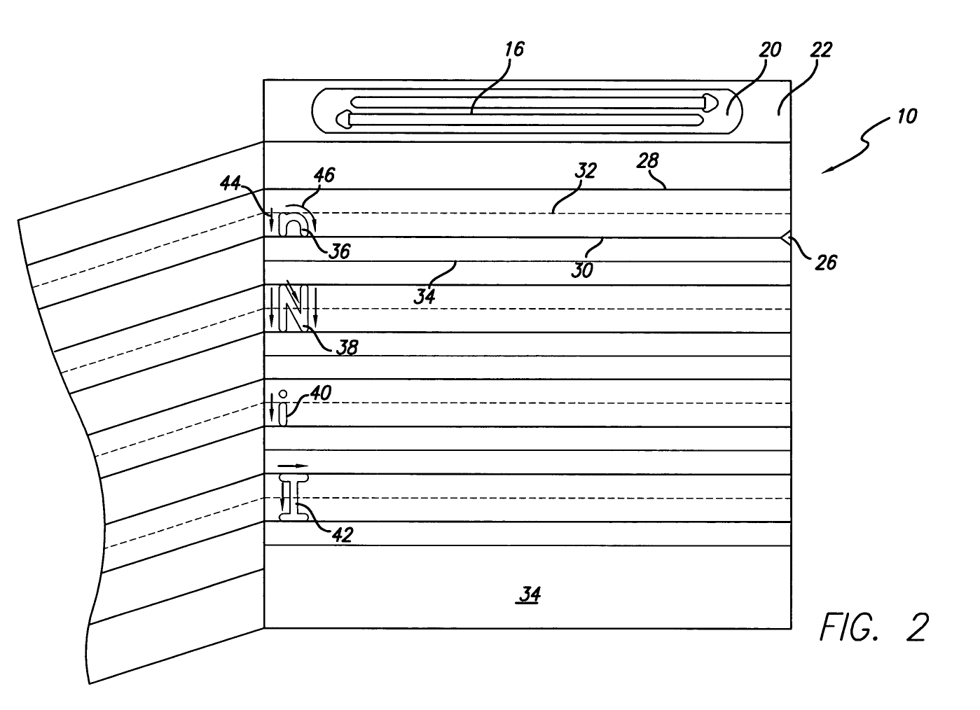

Turning next to FIG. 2, there is shown in perspective view, the learning guide 10 with the work book 16 opened to one of the work pages 24. In the preferred embodiment, each of the pages 24 has sets of lines 26 to provide work spaces within which the alphanumeric characters can be drawn. In the preferred embodiment, each set of lines 26 includes an upper, capital letter limit 28, a lower case letter limit 30, a dashed line 32 as an upper limit guide for lower case letters and a set separator 34. In the preferred embodiments, each of the lines of the set 26 is in a different color to aid in identifying a particular line.

On each set of lines 26, the outline of a character is placed for reference. As shown, on successive lines there is a lower case “n” 36, an upper case “N” 38, a lower case “i” 40 and an upper case “I” 42. Additional matter is provided for guidance in creating the characters such as a straight arrow 44 adjacent the straight segment of the “n” 36 and a curved arrow 46 adjacent the curved portion of the “n” 36.

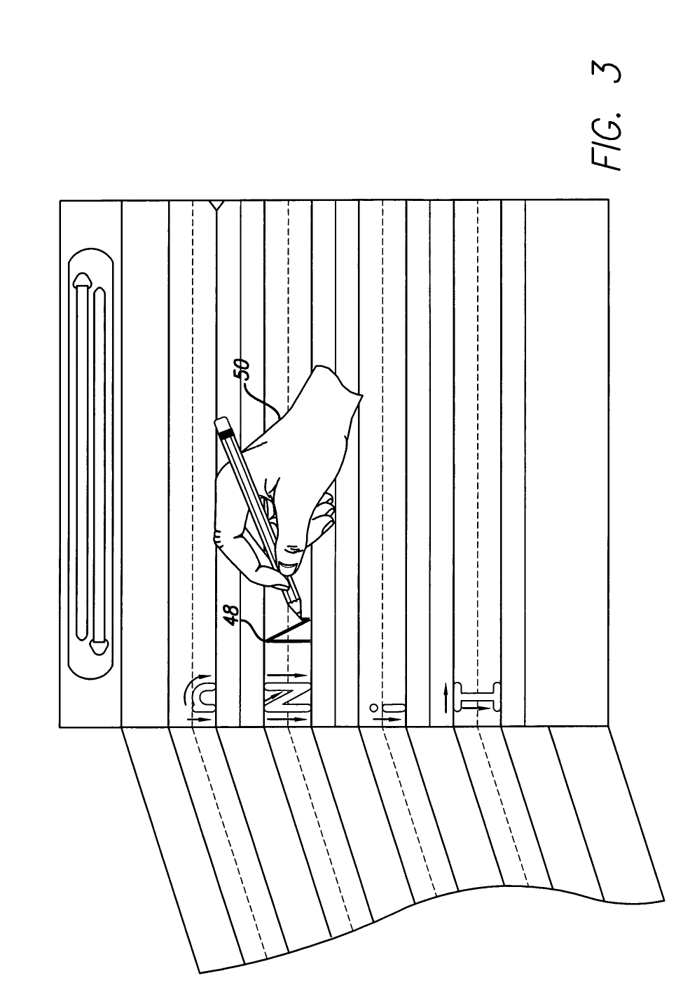

Referring now to FIG. 3, a depiction of a sample screen from the preferred embodiment of interactive literacy learning guide 10 is depicted. A partially formed “N” 48 is depicted. This letter is being exemplified by the exemplar hand 50 on the screen. When the learner views the materials on the disk, the learner is shown how to create the letters in much the same manner as would be employed by an in person teaching professional. In the preferred embodiment, the exemplar is a cartoon or puppet character for children.

In a first alternative embodiment, such as one for an adult audience, the exemplar may include an individual or simply text being drawn on the screen. In the preferred embodiment, the exemplar hand 50 is depicted creating the characters one or more times to aid the learner in grasping the correct methodology for forming a particular character.

The text of the partially formed “N” 48 will be completed by the exemplar hand 50 slowly, so that the learner may grasp the methodology. In the preferred embodiment, in between and along with the instruction in creating the characters, entertaining and playful characters help to maintain a child's interest while learning through interaction with the child. In alternative embodiments, little or no such interaction, apart from the instruction in the way in which to create the characters, may be given.

Accordingly, an interactive literacy learning guide has been described. It is to be understood that the description above is not intended to limit the scope of the invention beyond that of the description of the invention in the claims. Alternative embodiments, other than those depicted herein, may still be within the scope and spirit of the invention. The invention is only limited to extend described in the following claims.

What is claimed as new is:

1. An apparatus for use in teaching writing skills, comprising:
a least one workbook having pages including spaces for completing practice characters;
at least one data storage device, included with said workbook, which is prerecorded with audiovisual images including exemplars of practice characters; and
at least one writing implement, included with said workbook, for creating practice characters.

2. The apparatus of claim 1 wherein said workbook's pages are designed for use with dry-erase markers.

3. The apparatus of claim 1, wherein said data storage device includes audiovisual depictions of said practice characters being created.

4. The apparatus of claim 2 wherein said writing implement is a dry-erase marker for use on said workbook's pages.

5. The apparatus of claim 1 wherein said data storage device is a digital video disk.

6. The apparatus of claim 1 wherein said data storage device is a video cassette.

7. An apparatus for use in teaching writing skills, comprising:
a workbook having pages including spaces for creating practice characters;
at least one prerecorded data storage device, included with said workbook, which includes exemplars of said practice characters being created; and
at least one writing implement, included with said workbook, for creating practice characters in said workbook.
